(19) United States
(12) Patent Application Publication
(10) Pub. No.: US 2007/0029704 A1
(43) Pub. Date: Feb. 8, 2007

(54) Method and device for injecting an injection molded part made of plastic

(76) Inventor: Ralph Gauss, Luxemburg (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/559,542

(22) PCT Filed: Jun. 3, 2004
(86) PCT No.: PCT/EP04/06000

§ 371 Date: Jan. 18, 2006

(30) Foreign Application Priority Data
Jun. 3, 2003 (DE) 102 25 260.6

(51) Int. Cl. B29C 45/00

(52) U.S. Cl. 264/328.1

(57) ABSTRACT

The invention relates to a method for injecting an injection molded part made of plastic, using an injection unit having a gate (1) in a nozzle housing (2), the gate (1) being connected to a flow channel (5). According to the invention, the gate (1) is opened and closed by an inner needle (4), and plastic flowing from the flow channel (5) to the gate (1) is predosed and injected by an outer needle (3), and/or a retention pressure is applied to the plastic.

The invention relates to a method for injecting an injection molded part made of plastic, using a gate in a nozzle housing, the gate being connected to a flow channel, and a device for this purpose.

### PRIOR ART

Injection molding of plastic is usually carried out in such a way that the plastic is brought to the melting point, in an extruder, for example, and is led through a flow channel (hot runner) of a nozzle tip, through which the plastic is injected into a cavity. The plastic cools there, and then can be removed from the cavity.

It is known to close off the transition between the flow channel and the cavity by means of a body (needle), for example to prevent the plastic from dripping.

It is known that, for example in injection molding of very small parts weighing less than 1 gram, relatively large volumes of plastic may result in damage to the plastic material by degradation caused by excessive residence times inside the hot injection unit.

For such applications it is therefore optimal to reduce the volume of plastic in the injection unit by making the path between the injection molding machine and the mold cavity as short as possible, or to eliminate same. This would be achieved by more or less integrating the machine into a hot runner, or by having other functions of the machines, such as dosing, assumed by the injection unit.

In the injection molding of very thick-walled components such as optical components, for example, very long retention times are necessary to compensate for molded part shrinkage. Nozzle tips may result in orientation of the material, thereby impairing the optical properties.

### OBJECT

The object of the present invention is to develop a method and a device of the aforementioned type by which injection molded parts may be more rapidly and easily manufactured.

### ACHIEVEMENT OF THE OBJECT

The object is achieved by the gate being opened and closed by an inner needle, and plastic flowing from the flow channel to the gate being predosed and injected by an outer needle, and/or a retention pressure being applied to the plastic.

This invention provides that a very small component, for example, may be manufactured by dosing exactly the quantity of material needed for the component. This is achieved by the inner shutoff needle holding the gate closed during dosing of the plastic, thereby preventing the liquid plastic from flowing out.

When the necessary quantity of plastic has been predosed, the inner shutoff needle is opened and the predosed plastic material is conveyed into the mold cavity by a lifting motion of the outer needle. Additional material can then be introduced into the mold cavity by a further lifting motion of the outer needle to compensate for any shrinkage. At the end of the lifting motion of the outer needle or at the end of the retention time, the inner needle closes the gate and the cooling time begins.

The inner needle is preferably guided inside the outer needle, which in turn performs a lifting motion in the nozzle housing. High precision is achieved by guiding the inner needle inside the outer needle. This guiding of the needle allows wear on this inner needle to be minimized. The inner needle is constrained in such a way that it is able to precisely close the gate in a defined manner. The precentering further allows maximum heat exchange between the hot and cold sides, thereby enabling high-quality gating due to optimal cooling. High optical quality for the gating is also achieved.

As a result of guiding the inner needle inside the outer needle, the size of the inner needle may be reduced by several times, in particular with respect to its diameter, without the risk of buckling. It is thus possible to close even the smallest gates with the appropriate needle. This is important in the manufacture of microcomponents.

The manner in which the motion of the needle is controlled is not of major importance. The motion may be produced by mechanical, hydraulic, or electrical means.

If desired, interplay in the opening and closing of both needles may be provided. In this manner the plastic is predosed, injected, or subjected to a retention pressure. This control allows flexible adaptation to various applications or types of plastic. This also means that small nozzles, for example, can be directly controlled, and the above-described cycle can be adapted to various plastic parts in a temporally variable manner.

As a rule, it is advisable to provide a blocking element in the flow channel so that the melt does not back up into the flow channel during injection of plastic or application of a retention pressure. The design of this blocking element is not of major importance. Here as well, a needle closure, rotary lock, or the like may be used for this purpose.

The volume of plastic inside the injection unit or inside the filling space should preferably be essentially zero at the end of the injection process or the application of retention pressure. This means that at the end of the injection process the outer needle is situated close enough to the base of the filling space, or to the end of the cavity, or to the end of the cavity inset for the tool that dead zones or material residues resulting from a positive fit are largely avoided. Since a prechamber is no longer provided, as is the case for nozzles of the prior art, the entire space for the melt is reduced in the injection unit.

Thus, in a single- or multicavity tool the “hot runner nozzle” has now directly assumed the function of the injection unit for the machine, thereby primarily reducing residence time of the plastic in a controlled manner. Since the degradation is reduced as well, a very large number of parts may be manufactured in a short time while minimizing rejects.

In a multicavity tool, the injection unit according to the invention, for example, may be directly designed as a pressure-transmitting injection unit. A pressure-transmitting injection molding unit for the machine is thus omitted entirely, and only material supply in the form of material transport is required. In this regard, it is important that locking permits a counterpressure to be built up at the inlet. This allows new machine designs, especially in light of the fact that for microparts, lifting motions by a plastic machine are hardly needed in the classical sense.

Since the injection unit and the inner needle are able to open directly at the gate, flow marks, which typically arise as the result of nozzle tips, are completely eliminated. This is accomplished by having the outer needle assume the function of the nozzle tip. Thus, a “passive” nozzle tip is omitted entirely, and the injection unit itself becomes a nozzle tip of a sort.

In the classical sense, nozzle tips enable the targeted separation from the hot side to the cold side (HT/VG). In particular for microcomponents, this function must be entirely reconsidered, since the sprue residues exceed by far the weight of the component (even including the hot runner).

The present invention also allows a very specialized method. This finds application in particular for microcomponents or small components, and is known as injection compression molding. According to the invention, the injection compression molding occurs within the hot runner, in front of the gate itself. A core/cavity is introduced from the cold side into the gate or the hot runner after the gate, thereby controlling melt transport and pressure buildup from the hot side. The core, having a cavity facing the end side, for example, cooperates with the tip of the inside needle. In order to introduce the melt from the filling space under pressure from the outer needle, the space between the tip of the core and the inner needle is briefly opened so that plastic material can flow into the cavity. Closing off the core and inner needle causes the remaining material to be displaced. Melt cooling and ejection then take place totally or partially on the cold side by allowing the needle and core to travel once again to the cold side in a controlled manner.

If the inner needle is also provided with a locking element, it is also able to act as a shaping part, whereby it has a corresponding contour, and has a surface which does not face only the end side.

The present invention also provides that the injection unit according to the invention is independently used as a pump system for injecting duroplasts or elastomers in addition to the thermoplastic application. The injection units are openly placed on injection points for “hot” tools for elastomers or duroplasts. The melt is fed through the “pump,” which after trapping and pressure buildup is able to transport the duroplasts or elastomers into the hot tool. Multiple nozzles may be combined into a single mixing unit; i.e., any given number of nozzles lead into a mixing nozzle in a controlled manner. Feeding of the material is assumed by a conveying unit. The nozzle system performs the material discharge, mixing, and pressure buildup.

Lastly, the above-mentioned injection unit may also be used for co-injection (two-color nozzle). In this case, at least one additional flow channel opens into the filling space, it being possible to also block this flow channel by a blocking element acting as a backflow valve.

A further embodiment of the invention provides that the first flow channel is allowed to flow in at a short distance below the gate, so that the inner needle can close and open this first flow channel. The second flow channel then opens into the filling space, preferably at the beginning of the inclined area, where the outer needle meets after the melt has been pressed from the filling space. This allows the melt to be added separately from the first or second flow channel in a more precise manner.

### DESCRIPTION OF FIGURES

Further advantages, features, and particulars of the invention result from the following description of preferred embodiments, and with reference to the drawings, which show the following:

FIG. 1 shows a schematically illustrated cross section of an injection unit according to the invention;

FIGS. 2 through 4 show schematically illustrated cross sections of the injection unit according to FIG. 1, in additional positions of use;

FIG. 5 shows a schematically illustrated cross section of a further embodiment of a injection unit; and

FIG. 6 shows a schematically illustrated cross section of a further embodiment of an injection unit.

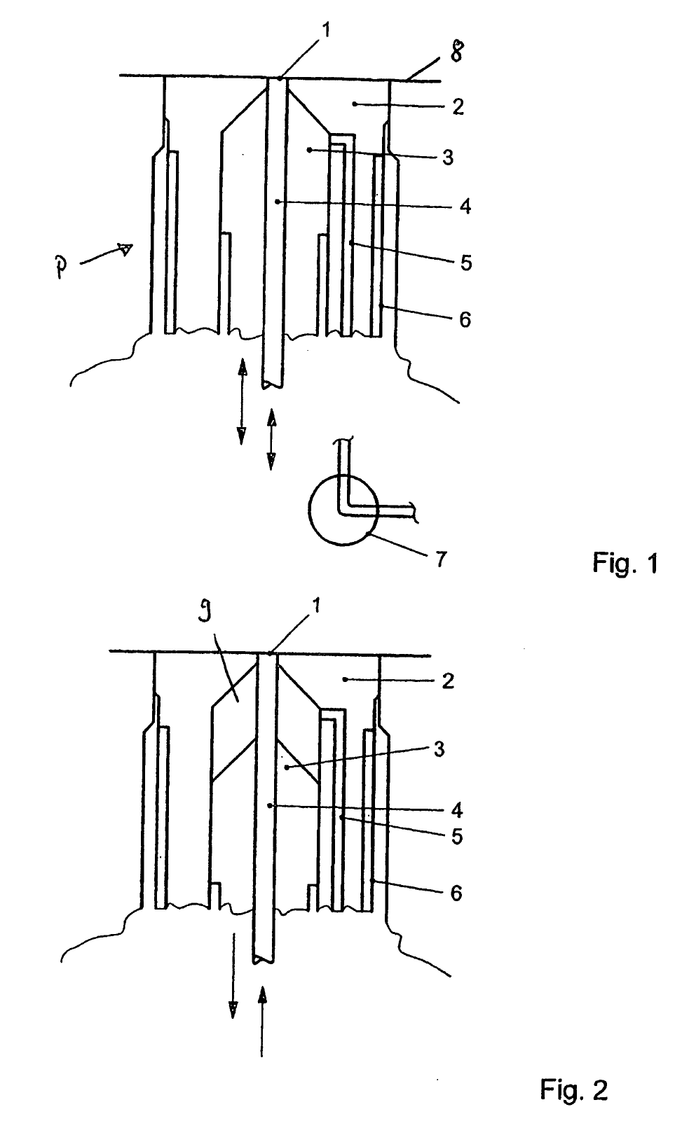

An injection unit illustrated in FIG. 1 has a gate 1, a nozzle housing 2, an outer needle 3, and inner needle 4, a flow channel 5, heater 6, and a shutoff valve 7.

The inner needle 4 runs cylindrically or at an angle to the end of the needle into the gate 1. The outer needle 3 runs so as to enclose the inner needle 4, inside the housing 2. The outer needle 3 releases the lateral inflow (from the nozzle housing). The nozzle housing 2 is blocked or sectionalized at this location.

Alternatively, it is also possible to feed the material from the inner or outer needle 3, 4, in which case the needles are designed as hollow needles. It is also possible to provide an additional needle for controlling the melt. The needle would then run around the exterior, or within the housing.

The motions are controlled and regulated by a control unit (computer) or by the melt flow itself. The control system is optionally connected to time, pressure, or displacement sensors.

The shutoff valve 7 as such may be specified in various ways (by needle or rotary valve), it being important only that during blocking an action (pressure) opposed to the injection pressure is produced. The shutoff valve 7 may be located inside or outside the injection nozzle.

The lifting motions of both needles are enabled by a drive having electric motors (for example, sequentially installed step motors) because of the high-precision motions in microinjection molding. However, a pneumatic or hydraulic drive is also possible for larger components.

The mode of operation of the present invention is described in greater detail, with reference to FIGS. 2 through 4.

The injection unit P contacts a separating line 8 of a cold side of the mold, resulting in a cavity on the gate 1, on the cold side. The injection unit P, in contrast, forms a part of the hot tool side.

According to FIG. 1, the gate 1, i.e., the opening to the cavity, is closed by the inner needle 4. A corresponding closing pressure is exerted on both the inner needle 4 and the outer needle 3. The shutoff valve 7 is in the open position.

According to FIG. 2, the outer needle is now pulled back so that a filling space 9 is formed around the inner needle 4. The flow channel 5 opens into this filling space 9, thus allowing the melt to enter the filling space 9 when the valve 7 is opened. A negative pressure in the filling space 9 resulting from pulling back the outer needle 3 can even draw in the melt, thereby accelerating the filling process. Predosing occurs by the selection of the size of the filling space 9.

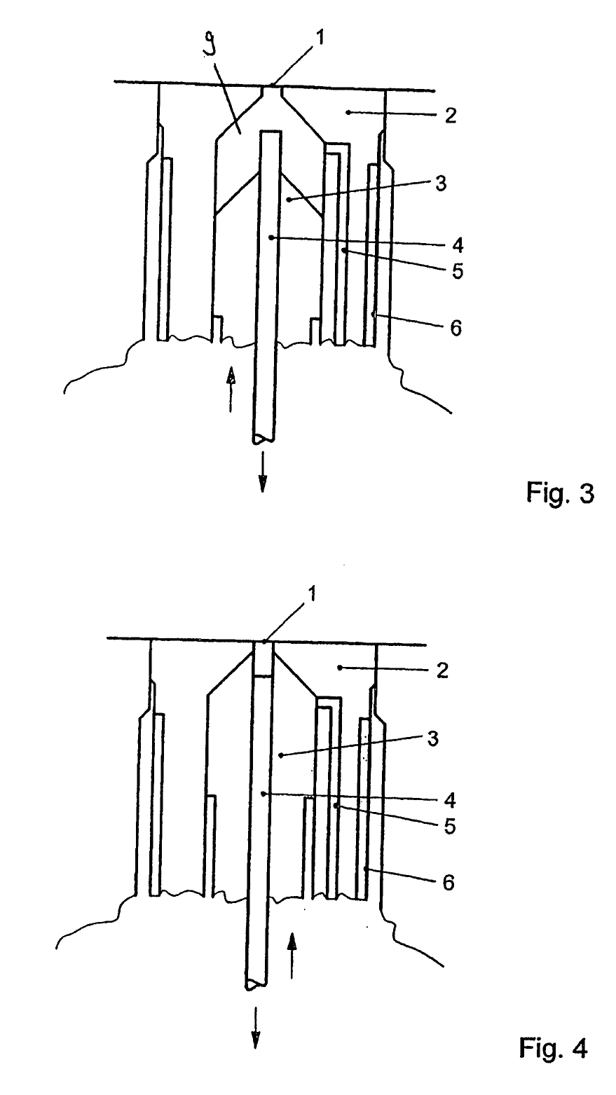

According to FIG. 3, the inner needle 4 is pulled back so that the gate 1 opens. The valve 7 is closed, and pressure is exerted on the outer needle 3. Melt is thereby discharged from the filling space 9, through the gate 1 and into a cavity on the “cold” side.

The process according to FIGS. 2 and 3 may be repeated multiple times, thus “pumping” melt into the cavity.

When the cavity is adequately filled, pressure is still exerted through the outer needle 3, which can be caused by the filling space not being completely pressed out through the outer needle 3. Under this retention pressure the plastic is able to harden in the cavity, or plastic is subsequently ejected as the result of shrinkage in the cavity.

The last step involves closing of the gate 1 by the inner needle 4, as shown in FIG. 1.

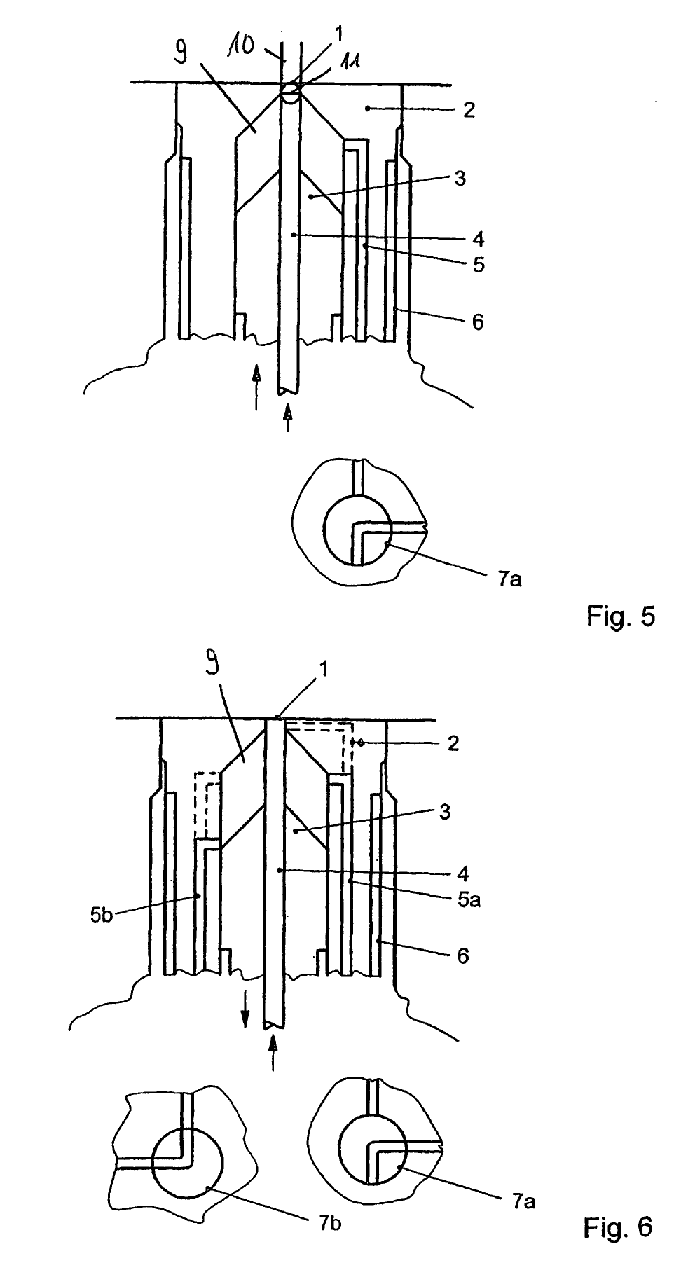

In a further embodiment of the invention according to FIG. 5, a cavity 11 is formed in the gate 1 through a core 10 and the inner needle 4, and can be filled with plastic melt from the filling space 9. In this case, first the core 10 closes the gate 1, and then the valve 7a is opened, enabling plastic to flow through the flow channel 5 into the filling space 9. If the inner needle 4 is now also pulled back, plastic melt is able to enter in front of the end face of the core 10. At this point the inner needle 4 is moved toward the core 10, thereby isolating the plastic melt in the cavity 11 from the filling space 9. The plastic part molded at this location is then ejected to the cold side when the core 10 recedes.

In the embodiment of an injection unit according to FIG. 6, two flow channels 5a and 5b open into the filling space 9. Both flow channels are respectively provided with a valve 7a and 7b. This injection unit lends itself primarily to co-injection. The two valves 7a and 7b may be differently controlled.

In this embodiment shown in FIG. 6, it is also possible to allow the flow channel 5a, indicated by dashed lines, to discharge a short distance below the gate 1. In this case, the inner needle 4 is used to open and close this flow channel; i.e., the inner needle 4 can be opened, and via the flow channel 5a melt can be directly introduced into a cavity through the gate. The inner needle 4 is then preferably used to also block the filling space 9, provided that it is not intended for melt from this filling space 9 to likewise enter the cavity. Only when this is intended is the inner needle 4 pulled back further, thereby opening the passage to the cavity.

In this embodiment, the second flow channel 5b preferably opens into the filling space 9, near the base thereof, which is designed here as an inclined area.

1-21. (canceled)

22. A method for injecting an injection molded part made of plastic, using an injection unit having a gate in a nozzle housing, the gate being connected to a flow channel which opens into a filling space in which an outer needle, and within same an inner needle for closing the gate, are guided, the outer needle first being pulled back, thereby forming a filling space, and plastic is drawn in from the flow channel and the filling space is predosed with plastic from the flow channel, during which the inner needle holds the gate closed, and at the end or after predosing, the gate is opened by lifting the inner needle, and the predosed plastic material is pressed through the gate into a cavity by a lifting motion of the outer needle, the volume of plastic inside the filling space being essentially zero at the end of the injection process or of the application of retention pressure, and the inner needle closes the gate at the end of the lifting motion of the outer needle or at the end of a predetermined retention time.

23. The method according to claim 22, wherein the base of the filling space runs at an angle toward the gate, and the tip of the outer needle has a corresponding design.

24. The method according to claim 22, wherein the flow channel opens into the filling space, near the base thereof.

25. The method according to claim 22, wherein the lifting motion of the inner and/or outer needle is produced by mechanical, hydraulic, or electrical means.

26. The method according to claim 22, wherein additional plastic material is introduced into the cavity, also to compensate for any shrinkage, by at least one further lifting motion of the outer needle.

27. The method according to claim 22, wherein additional plastic material is introduced into the filling space through at least one second, blockable flow channel.

28. The method according to claim 27, wherein the inner needle is pulled back and a flow channel is opened, via which melt is introduced directly into the cavity through the gate, while the inner needle continues to block the filling space.

29. The method according to claim 28, wherein the inner needle is pulled back further, and the passage from the filling space to the cavity is opened.

30. A device for injecting an injection molded part made of plastic, having a gate in a nozzle housing, the gate being connected to a flow channel, and an inner needle is provided in the gate in the nozzle housing, and an outer needle is provided for dosing, pressing, and optionally applying pressure to the melt, the flow channel opening into a filling space in which the outer needle is also guided, wherein the flow channel opens into the filling space, at the base thereof.

31. The device according to claim 30, wherein the base of the filling space runs at an angle toward the gate, and the tip of the outer needle has a corresponding design.

32. The device according to claim 30, wherein a blocking element is provided in the flow channel.

33. The device according to claim 30, wherein at least one additional flow channel opens into the filling space and is likewise provided with a blocking element.

34. The device according to claim 33, wherein the flow channel discharges a short distance below the gate, while the flow channel opens into the filling space, near the base thereof.

35. The device according to claim 30, wherein the nozzle housing forms an injection unit with the two needles and the flow channel(s), and the injection unit may be associated with a cavity.

36. A method for injecting an injection molded part made of plastic using an injection unit, the injection unit comprising a nozzle housing, a gate contained within the nozzle housing, a filling space, a flow channel in communication with the filling space for introducing plastic into the filling space, an outer needle movable to change a volume of the filling space, and an inner needle movable to control flow of plastic through the gate, the method comprising:
moving the outer needle a first direction to draw plastic into the filling space from the flow channel while preventing the flow of plastic through the gate with the inner needle;
moving the inner needle to open the gate; and
moving the outer needle a second direction to move plastic through the gate.
